(19) United States
(12) Patent Application Publication
(10) Pub. No.: US 2002/0020118 A1
(43) Pub. Date: Feb. 21, 2002

(54) Refrigerator door

(76) Inventors: Richard Horn, Herbrechtingen (DE); Jurgen Hirath, Bayreuth (DE); Ulrich Wolf, Giengen (DE); Wolfgang Kentner, Rofingen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/933,054

(22) Filed: Aug. 20, 2001

Related U.S. Application Data
(63) Continuation of application No. PCT/EP00/00828, filed on Feb. 2, 2000.

(30) Foreign Application Priority Data
Feb. 19, 1999 (DE) 199 07 147.0

(51) Int. Cl. E06B 7/16

(52) U.S. Cl. 49/482.1

(57) ABSTRACT

A refrigerator door includes an outer paneling and an inner paneling spaced therefrom. The inner and outer panelings are made from a metallic material. Both form a transition point at their edges that receives between them a thermal insulation layer produced by foaming. A thermally insulating couple connects the edge portions of the panelings and substantially thermally uncouples the edge portions from one another.

### BACKGROUND OF THE INVENTION

1. Field of the Invention

The invention lies in the field of heat insulating walls. The invention relates to a refrigerator door with an outer paneling formed from metallic material, an inner paneling spaced from the outer paneling, and a thermal insulation layer provided between the outer and inner panelings.

2. Prior Art

Refrigerator doors have an outer paneling formed from sheet steel provided with a lacquer coating and a plastic inner paneling spaced from the outer paneling. The inner paneling is connected to the outer paneling by a foaming thermal insulation layer. The plastic inner panelings used in the prior art refrigerator doors are manufactured virtually exclusively by the deep drawing of a plastic blank. The wall thickness of the blank is narrowed appreciably, depending on the configuration of the inner door, especially when projecting spars for the mounting of door storage compartments are integrally formed on the inner door. The production-related reduction in wall thickness of the plastic blank (which has low inherent rigidity) has an effect that, in light of the large quantities occurring in the consumer goods industry, only fastening measures involving an outlay that is justifiable in manufacturing terms are employed because some inherent rigidity at the fastening points is achieved by these shapings. Such manufacturing terms, for example, include integrally formed holding bosses or else receptacles of dovetail-like shape. Other holding measures that are not aimed at special shaping for stiffening the inner paneling and that would allow a much more flexible configuration of the door storage compartments on the inner paneling, because of the low dimensional rigidity of the inner paneling manufactured from plastic, can be obtained only by using backing parts that increase the manufacturing costs of the refrigerator door. Furthermore, the inner paneling, which, in part, is greatly impaired as a consequence of production because of its wall thickness, runs the risk of being damaged at the points having reduced wall thickness.

### SUMMARY OF THE INVENTION

It is accordingly an object of the invention to provide a refrigerator door that overcomes the hereinafore-mentioned disadvantages of the heretofore-known devices of this general type and that improves a refrigerator door with an outer paneling and an inner paneling spaced therefrom both formed from metallic material and with a thermal insulation layer provided therebetween and produced of foam by simple structural measures, particularly, in terms of usefulness.

With the foregoing and other objects in view, there is provided, in accordance with the invention, a refrigerator door including an outer paneling having a free edge portion and being made from a metallic material, an inner paneling having an edge portion and being made from metallic material, a thermal insulation layer produced by foaming, and a thermally insulating couple connecting the edge portion to the free edge portion. The inner paneling is spaced from the outer paneling and the thermal insulation layer is disposed between the outer paneling and the inner paneling. The couple substantially thermally uncouples the edge portion from the free edge portion.

The refrigerator door according to the invention forms the inner paneling from a metallic material.

An inner paneling configured with markedly higher inherent rigidity than the conventional inner paneling affords the possibility that the inner paneling can be made more variably in terms of its configuration and fastening positions for the door storage compartments. These results are achieved because such an inner paneling does not have to be stiffened by a special shaping for holding the door storage compartments. Thus, for example, it is possible, in cost-effective welding or screwing structures, to provide, essentially over the entire area of the inner paneling, shelf-like fastening possibilities that allow a markedly more flexible configuration of the door storage compartments. Moreover, it is possible in a simple and cost-effective way, without the aid of backing parts, to provide bearing points with long-term resistance for pivotable retaining clips for bottle-like storable goods. Furthermore, the refrigerator door in a simple way acquires the appearance of having a greater value, thus, giving rise to a product differentiation that can be seen to have various advantages and, at the same time, is immediately apparent. In addition, an inner paneling manufactured from metallic material has the advantage that, even in the case of stubborn dirt, it can be cleaned intensively in a particularly simple way. Also, by using an inner cladding manufactured from metallic material, the entire door body acquires a markedly higher distortion resistance that is essential, particularly, in the case of large-area refrigerator doors.

In accordance with another feature of the invention, the inner paneling is at least as far as possible uncoupled at its free edge portions from the free edge portions of the outer paneling by a thermal insulation device or means for thermally insulatingly coupling.

To form an interface, the free edge portions of the inner paneling and of the outer paneling may either be located opposite one another with a spacing or be disposed so as to overlap with a vertical spacing from one another. In both cases, a heat conduction preventing device between panelings and taking the form of, for example, thermally insulating material, for example, also configured as moldings, is inserted between the panelings to avoid a heat flow.

By employing a thermal insulation device at the interface between the free edge portions of the inner paneling and the free edge portions of the outer paneling, a thermal short circuit greatly reducing the heat insulation of the door is avoided in a simple way between the inner paneling exposed to the temperatures in the refrigerating space of the refrigerator and the outer paneling subjected to the ambient temperature of the refrigerator.

Uncoupling to avoid a heat flow through the interface between the free edge portions of the outer paneling and those of the inner paneling can be brought about in a particularly simple way during the foam-filling process when, in accordance with a further feature of the invention, the thermal insulation device is formed as thermal insulation material disposed between the free edge portions of the inner and outer panelings.

In accordance with an added feature of the invention, the thermal insulation device is configured as a fastening element of a door seal produced from plastic, the fastening element being disposed between the edge portions of the outer paneling and the edge portions of the inner paneling. Using a seal foot of a door seal for the thermal uncoupling of the free edge portions of the inner paneling from those of the outer paneling has an effect of both thermal uncoupling and the fastening of the door seal with a single component.

By using a plastic profile as a medium interrupting heat conduction at the interface between the free edges of the outer paneling and those of the inner paneling, conventional door seals, with a differently configured seal foot, can be fastened to the refrigerator door. In the event of the plastic profile being configured as an intermediate piece capable of being inserted into a gap between the free edges of the inner and outer panelings, a particularly highly effective prevention of heat conduction between the inner paneling exposed to the temperatures of the refrigerating space and the outer paneling subjected to the ambient temperature of the refrigerator is achieved.

In accordance with an additional feature of the invention, the thermal insulation device is configured as a plastic profile that is disposed between the free edge portions of the inner paneling and outer paneling, fixes the edges of the inner and outer panelings, and has a receptacle for releasably holding a door seal.

In accordance with yet another feature of the invention, the plastic profile has at least one receptacle, and at least one of the door seal, the edge portion, and the free edge portion is inserted into the at least one receptacle.

The plastic profile is held particularly securely when, in accordance with yet a further feature of the invention, the plastic profile has at least one receiving groove that fixes the edges of the free edge portions of the inner and outer panelings. By holding the free edges of the edge portions of the inner and outer panelings by at least one receiving groove, tolerance fluctuations between the mutually opposite free edges of the inner and outer panelings can be intercepted particularly easily. The plastic profile can have two receiving grooves.

In accordance with a concomitant feature of the invention, the inner paneling is formed, at least as far as possible in a non-cutting manner, from a special-steel blank. By using special steel, a particularly hard-wearing inner paneling can be provided that has high inherent rigidity, even in the case of a small blank wall thickness, and that, without additional measures, gives the refrigerator door the appearance of having a greater value.

Other features that are considered as characteristic for the invention are set forth in the appended claims.

Although the invention is illustrated and described herein as embodied in a refrigerator door, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic, fragmentary, cross-sectional view of a first embodiment of a refrigerator door according to the invention with a plastic profile holding a magnetic seal and introduced between free edge portions of inner and outer panelings;

FIG. 2 is a diagrammatic, fragmentary, cross-sectional view of a second embodiment of the refrigerator door of FIG. 1 with a seal foot of a magnetic seal introduced between free edge portions of the inner and outer panelings for thermal uncoupling;

FIG. 3 is a diagrammatic, fragmentary, cross-sectional view of the third embodiment of the refrigerator door of FIG. 1 with a seal foot for thermal uncoupling in a horizontal gap between free edge portions of the inner and outer panelings; and

FIG. 4 is a diagrammatic, fragmentary, cross-sectional view of a fourth embodiment of the refrigerator door of FIG. 1 with a plastic profile introduced for thermal uncoupling in an intermediate region between free edges of the inner and outer panelings.

### DESCRIPTION OF THE PREFERRED EMBODIMENTS

In all the figures of the drawing, sub-features and integral parts that correspond to one another bear the same reference symbol in each case.

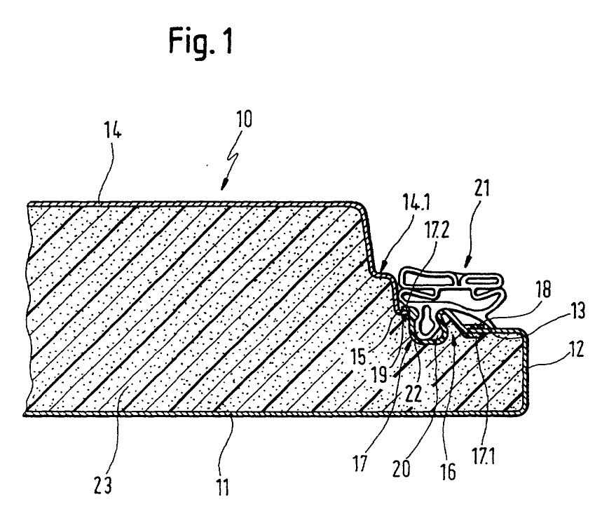

Referring now to the figures of the drawings in detail and first, particularly to FIG. 1 thereof, there is shown a simplified diagrammatic illustration of a refrigerator door 10, configured as a freezer cabinet door, with an outer paneling 11 that serves a visible cover and that is manufactured from metallic material, such as sheet steel or the like, and has a peripherally disposed surround 12 with a free edge portion 13 that points into the door interior. The refrigerator door 10 possesses, spaced from the outer paneling 11, an inner paneling 14 that is manufactured likewise from metallic material, such as, for example, a special-steel blank or the like, and that has a step-like shoulder 14.1 disposed peripherally near the edge and has a free edge portion 15. The free edge portion 15 points in the direction of the free edge portion 13, but is disposed, however, offset vertically and spaced from the free edge portion 13. As a result, a clearance 16 is produced peripherally between the free edge portions 13 and 15. The clearance 16 is bridged by a plastic profile 17 with holding ends 17.1 and 17.2, on which are provided groove-like receptacles 18 and 19, of which the receptacle 18 faces the edge portion 13 and the receptacle 19 faces the edge portion 15. The groove-like receptacles 18, 19 each possess a groove orifice that faces the edge portion 13 or 15 and through which the free edge portion 13, 15 can be inserted into the respective groove-like receptacle 18, 19. The receptacles 18, 19 are coordinated in terms of their groove width with the material thickness of the edge portions 13, 15. As a result, the edge portions 13, 15 are fixed and held in a liquid-tight manner. In addition to the receptacles 18, 19, the plastic profile 17 possesses an undercut receiving groove 20 disposed peripherally in the same way as the receptacles 18, 19. The receiving groove 20 serves to fix a seal foot 22 belonging to a magnetic seal 21 manufactured from plastic. The plastic profile 17 fixing the free edge portions 13, 15 in a liquid-tight manner prevents, at least as far as possible, heat conduction from the outer paneling 11 exposed to the ambient temperature to the inner paneling 14 and, together with the panelings 11, 14, delimits a cavity that is filled with a thermal insulation layer 23 that is processed in the form of liquid starting components and is produced by foaming. As a result of the adhesive action of the insulation layer 23, the inner paneling 14, the outer paneling 11, and the plastic profile 17 are connected to form a dimensionally rigid and distortion-resistant composite structure.

The inner paneling 14, described using the example of a freezer cabinet door 10, can also be used, with corresponding holding measures for door storage compartments secured, for example, by welding to the inner paneling 14, for a refrigerator cabinet door.

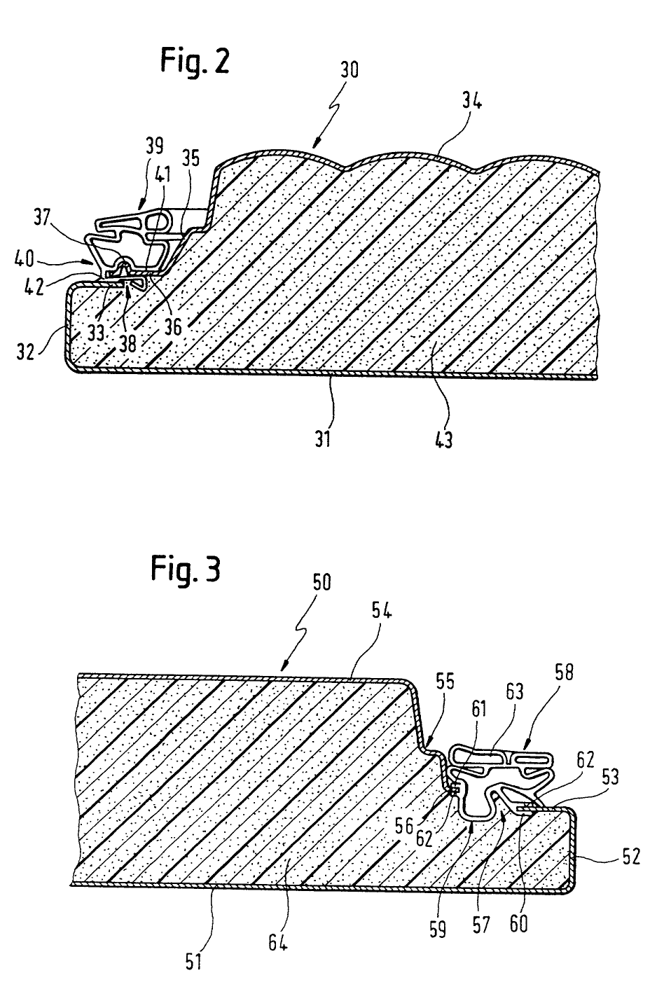

FIG. 2 illustrates a second embodiment of a refrigerator door 30 that, like the refrigerator door 10, is configured as a freezer cabinet door. The refrigerator door 30, like the refrigerator door 10, possesses an outer paneling 31 that is shaped from blank-like metallic material, such as lacquered sheet steel or the like, and has a peripherally disposed surround 32 possessing a free edge portion 33 that is oriented toward the door interior. Spaced from the outer paneling 31 is an inner paneling 34 that is shaped in the manner of a corrugated profile and is likewise produced from metallic material, such as a special-steel sheet blank or the like. The inner paneling 34 has at its edge a peripherally disposed step-like shoulder 35 with a free edge portion 36 lying in a plane parallel to the free edge portion 33. The edge portion 36 is provided, in the region near its free end, with a peripherally disposed holding bead 37 directed with its bead protuberance away from the free edge portion 33 and is disposed with a spacing above the free edge portion 33. As a result, due to the overlapping ends of the free edge portions 33, 36, a holding gap 38 is formed. The holding gap 38 fastens a magnetic seal 39 with a seal foot 40 that has a foot portion 41 capable of cooperating with the holding bead 37 and a foot portion 42 that can be inserted into the holding gap 38 and seated in a liquid-tight manner within the holding gap 38. The foot portion 42 prevents heat conduction between the inner paneling 34 and the outer paneling 31. The foot portion 42 provides a cavity that is delimited at least as far as possible in a liquid-tight manner by the inner paneling 34 and the outer paneling 31 and that is filled with thermal insulation material 43. The thermal insulation material 43 is capable of being processed in the form of liquid starting components and is produced by foaming. As a result of the adhesive action of the insulation material 43, the outer paneling 31 and the inner paneling 34 are connected to form an, as far as possible, dimensionally rigid and distortion-resistant door body.

FIG. 3 illustrates a further embodiment of a refrigerator door 50, configured as a freezer cabinet door. The refrigerator door 50 has an outer paneling 51 that serves as a visible cover and is manufactured from metallic material. Like the outer claddings 11, 31, the outer cladding 51 has a peripherally disposed surround 52 with a free edge portion 53 that is directed into the door interior. An inner paneling 54 is provided spaced from the outer paneling 51. The an inner paneling 54 is likewise shaped from blank-like material, such as, for example, special steel or the like, and, like the inner panelings 14, 34, has, in a region near its edge, a peripherally disposed step-like shoulder 55 with a free edge portion 56. The free edge portion 56 is directed in the direction of the free edge portion 53, but is disposed, offset vertically in a parallel plane and spaced from the free edge portion 53, thereby providing a clearance 57 disposed peripherally between the free edge portions 53, 56. In the embodiment, the clearance 57 is bridged by a fastening element belonging to a magnetic seal 58 and configured as a seal foot 59. The seal foot 59, like the plastic profile 17, possesses two holding elements 60, 61 that are integrally formed in a strip-like manner. Each of the two holding elements 60, 61 has a receiving groove 62 that is open toward the respective edge portions 53, 56 and that is coordinated in terms of its groove width with the material thickness of the respective edge portion 53, 56. Of the receiving grooves 62, the groove 62 provided on holding element 60 is connected in a liquid-tight manner to the free edge portion 53. The receiving groove 62 disposed on holding element 63 faces the edge portion 56 and is connected in a liquid-tight manner to the edge portion 56. In addition to the holding elements 60, 61 on the seal foot 59, the magnetic seal 58 possesses a seal head 63 that is connected elastically to the seal foot 59. The magnetic seal 58, with its seal foot 59 inserted in a liquid-tight manner as an intermediate element into the clearance 57, surrounds, together with the outer paneling 51 and the inner paneling 54, a cavity that is filled with foamable thermal insulation material 64. The thermal insulation material 64, by virtue of its adhesive action, connects the inner paneling 54, the outer paneling 51, and the magnetic seal 58 to form an, as far as possible, dimensionally rigid and distortion-resistant subassembly.

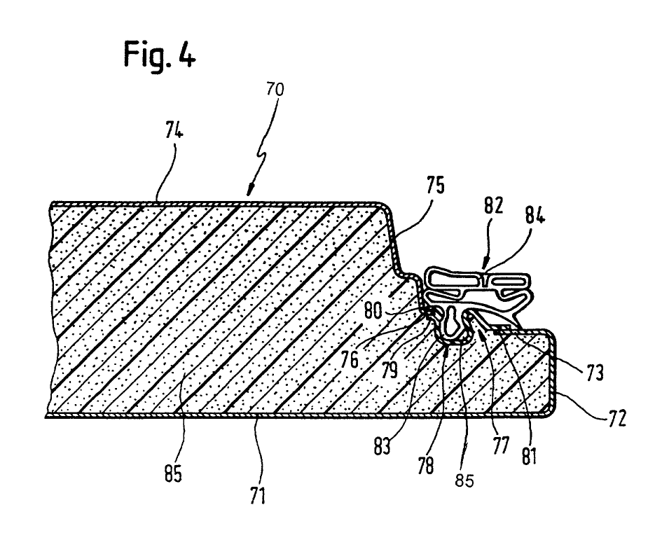

FIG. 4 illustrates a further embodiment of a refrigerator door 70, configured as a freezer cabinet door. The refrigerator door 70 is configured, as far as possible, in a similar way to the refrigerator door 10 illustrated in FIG. 1 and has an outer paneling 71 serving as a visible cover and made from a blank-like metallic material. The outer paneling 71 possesses a peripherally disposed surround 72 that has a free edge portion 73 directed into the door interior. The refrigerator door 70 is equipped, spaced from the outer paneling 71, with an inner paneling 74 that is manufactured likewise from blank-like metallic material and has a step-like shoulder 75 disposed peripherally in the region near the edge of the inner paneling 74. The step-like shoulder 75 has a free edge portion 76 pointing in a direction of the edge portion 73, but is disposed, offset vertically above the edge portion 73 in parallel and spaced from it. As a result, a clearance 77 running peripherally between the free edge portions 73, 76 is produced. The clearance 77 is bridged by a plastic profile 78 that is configured in a similar way to the plastic profile 17. The plastic profile 78 has a lateral strip-like holding element 79 facing the edge portion 76. The holding element 79 has a receiving groove 80 open toward the edge portion 76, and a likewise strip-like holding element 81 that faces the edge portion 73. In contrast to holding element 79, the holding element 81 is configured as a flat profile without a receiving groove. While the holding element 81 rests on the edge portion 73, so as to overlap the edge portion 73, the holding element 79 holds the edge portion 76. The edge portion 76 is inserted in a liquid-tight manner into the receiving groove 80. Between the holding elements 79 and 81, the plastic profile 78 possesses an undercut groove-like receptacle 85 that fastens a seal foot 83 belonging to a magnetic seal 82 manufactured from plastic. The seal foot 83 is connected elastically to a seal head 84 of the magnetic seal 82. The plastic profile 78 inserted into the clearance 77 and connecting the free edge portions 73 and 76 in a liquid-tight manner surrounds, together with the inner paneling 54 and the outer paneling 51, a cavity that is filled with a thermal insulation layer 86. The insulation layer 86 is produced by foaming and, by virtue of its adhesive properties, connects the outer paneling 71, the inner paneling 74, and the plastic profile 78 to form an, as far as possible, dimensionally rigid and distortion-resistant structural body.

We claim:

1. A refrigerator door, comprising:
an outer paneling having a free edge portion and being made from a metallic material;
an inner paneling having an edge portion and being made from metallic material, said inner paneling spaced from said outer paneling;
a thermal insulation layer produced by foaming, said thermal insulation layer disposed between said outer paneling and said inner paneling;
a thermally insulating couple connecting said edge portion to said free edge portion, said couple substantially thermally uncoupling said edge portion from said free edge portion.

2. The refrigerator door according to claim 1, wherein:
said thermally insulating couple is a plastic fastening element of a door seal; and
said fastening element is disposed between said edge portion and said free edge portion.

3. The refrigerator door according to claim 1, wherein said thermally insulating couple is a plastic profile with a receptacle, said plastic profile:
is disposed between said edge portion and said free edge portion;
bridges said edge portion and said free edge portion in a substantially liquid-tight manner; and
including a door seal, said receptacle releasably holding said door seal.

4. The refrigerator door according to claim 3, wherein:
said plastic profile has at least one receptacle; and
at least one of said door seal, said edge portion, and said free edge portion is inserted into said at least one receptacle.

5. The refrigerator door according to claim 3, wherein said plastic profile has at least one receiving groove fixing at least one of:
said edge portion of said inner paneling; and
said free edge portion of said outer paneling.

6. The refrigerator door according to claim 3, wherein said plastic profile has two receiving grooves fixing said edge portion and said free edge portion.

7. The refrigerator door according to claim 1, wherein:
the refrigerator door is to be connected to a door seal; and
said thermally insulating couple is a plastic profile with a receptacle, said plastic profile:
is disposed between said edge portion and said free edge portion;
bridges said edge portion and said free edge portion in a substantially liquid-tight manner; and
said receptacle is configured to releasably hold the door seal.

8. The refrigerator door according to claim 7, wherein:
said plastic profile has at least one receptacle; and
at least one of said edge portion and said free edge portion is inserted into said at least one receptacle.

9. The refrigerator door according to claim 7, wherein:
said plastic profile has at least one receptacle; and
at least one of the door seal, said edge portion, and said free edge portion is inserted into said at least one receptacle.

10. The refrigerator door according to claim 7, wherein said plastic profile has at least one receiving groove fixing at least one of:
said edge portion of said inner paneling; and
said free edge portion of said outer paneling.

11. The refrigerator door according to claim 7, wherein said plastic profile has two receiving grooves fixing said edge portion and said free edge portion.

12. The refrigerator door according to claim 1, wherein said inner paneling is formed from a special-steel blank.

13. The refrigerator door according to claim 12, wherein said inner paneling is substantially formed in a non-cutting manner.

14. The refrigerator door according to claim 12, wherein said inner paneling is substantially formed without cutting said inner paneling.

15. A refrigerator door, comprising:
an outer paneling having a free edge portion and being made from a metallic material;
an inner paneling having an edge portion and being made from metallic material, said inner paneling spaced from said outer paneling;
a thermal insulation layer produced by foaming, said thermal insulation layer being disposed between said outer paneling and said inner paneling;
a means for thermally insulatingly coupling said edge portion to said free edge portion, said coupling means substantially thermally uncoupling said edge portion from said free edge portion.
